(19) United States
(12) Patent Application Publication
(10) Pub. No.: US 2013/0299687 A1
(43) Pub. Date: Nov. 14, 2013

(54) Neutron Wellbore Imaging Tool

(71) Applicants: Hugh D. Scott, Katy, TX (US); Christian Stoller, Princeton Junction, NJ (US)

(72) Inventors: Hugh D. Scott, Katy, TX (US); Christian Stoller, Princeton Junction, NJ (US)

(73) Assignee: SCHLUMBERGER TECHNOLOGY CORPORATION, Sugar Land, TX (US)

(21) Appl. No.: 13/885,668

(22) PCT Filed: Nov. 15, 2011
(86) PCT No.: PCT/US11/60716

§ 371 Date: Jul. 26, 2013

Related U.S. Application Data
(60) Provisional application No. 61/415,434, filed on Nov. 19, 2010.

(51) Int. Cl. G01V 5/10

(52) U.S. Cl. CPC G01V 5/107; G01V 5/104
USPC 250/269.2; 250/269.4

(57) ABSTRACT

A method and apparatus for obtaining neutron images of a rock formation are provided. The neutron images can be obtained from a tool which need not rotate to obtain neutron data from a plurality of azimuthal orientations.

### BACKGROUND OF THE INVENTION

1. Field of the Invention

The invention relates generally to the field of imaging rock formations penetrated by a wellbore. More specifically, the invention relates to systems and methods for obtaining images of neutron properties of such rock formations with an instrument that need not rotate while making measurements around the circumference of a wellbore.

2. Background Art

Neutron well logging instruments of various types have been used for several decades to measure neutron properties, e.g., neutron porosity and hydrogen index of subsurface formations. State of the art neutron well logging instruments use electrically operated, pulsed neutron sources, and thermal and/or epithermal neutron detectors for measurement of the neutron at one or more longitudinal distances from the neutron source along the instrument. Additionally, neutron slowing down time as determined from measurements from one or more of the neutron detectors is a shallow measurement (i.e., laterally close to the instrument) of hydrogen index and is very sensitive to standoff. The neutron porosity measurement as made by neutron instruments known in the art relies on deriving the hydrogen index from the ratio of the neutron fluxes measured by at least two different neutron detectors each located at a different longitudinal distance from the neutron source.

Imaging measurements have been provided by various wellbore instruments known in the art. In wellbore measurement (“logging”) operations conducted using an instrument disposed at the end of an armored electrical cable extended into and withdrawn from a wellbore (“wireline”), such measurements include resistivity measurements as in the example of formation micro imaging (FMI), circumferential ultrasonic measurements and circumferential temperature measurements. In logging operations conducted using a drill string conveyed instrument (logging while drilling—“LWD”), nuclear (including, e.g., neutron and gamma-gamma density, photoelectric effect and induced gamma ray emission spectroscopy) imaging measurements are made possible due to the fact that the instrument may be rotated in the wellbore and azimuthally or circumferentially segmented measurements may be used to make an azimuthal scan of the surrounding formations as the instrument rotates in the wellbore. In the absence of instrument rotation, i.e. when the tool is “sliding” during directional drilling operations, no image can be acquired from the measurements made by such instruments. Similarly, “wireline” instruments generally cannot be rotated during operation, and as a result, it is not generally possible to obtain circumferentially segmented images of the subsurface formations.

Accordingly, there is a need for methods and systems for neutron wellbore circumferential imaging that can be obtained without the need to rotate the instrument.

### SUMMARY OF THE INVENTION

One aspect of the invention is a well logging instrument. The well logging instrument includes a neutron source and a first plurality of neutron detectors. The first plurality of neutron detectors are azimuthally separated from each other.

Another aspect of the invention is a method for logging a wellbore. A method for logging a wellbore according to this aspect of the invention includes imparting neutrons into a formation surrounding a wellbore. A neutron response of the formation surrounding the wellbore is measured in a plurality of substantially constant azimuthal orientations at positions proximate a wall of the wellbore.

Other aspects and advantages of the invention will be apparent from the following description and the appended claims.

### BRIEF DESCRIPTION OF THE DRAWINGS

FIG. 1 illustrates an example wireline neutron imaging.

FIGS. 2A-B illustrate different views of a neutron imaging instrument in its housing.

FIGS. 3A-B illustrate different views of a neutron imaging instrument in its housing.

FIG. 4 illustrates an example neutron imaging instrument with the addition of a gamma-ray detector.

FIG. 5 illustrates an example detector pad with two detectors each at a different longitudinal spacing from a neutron source.

FIGS. 6A-E illustrate various alternative example neutron detector configurations with multiple detectors at different azimuthal positions.

FIGS. 7A-B illustrate other alternative example neutron detector configurations.

FIG. 8 illustrates an example of two detectors in a pad separated by an intermediate space.

FIGS. 9A-B illustrate example neutron detectors on a pad.

### DETAILED DESCRIPTION

The invention provides methods and apparatus for obtaining neutron data and images of a rock formation with an instrument that needs not rotate while measuring, such as a wireline tool, slickline tool, tough logging conditions tool or drill-pipe conveyed tool. Methods and systems for obtaining such neutron-based images will now be described with reference to the Figures, which depict representative or illustrative example implementations of the invention.

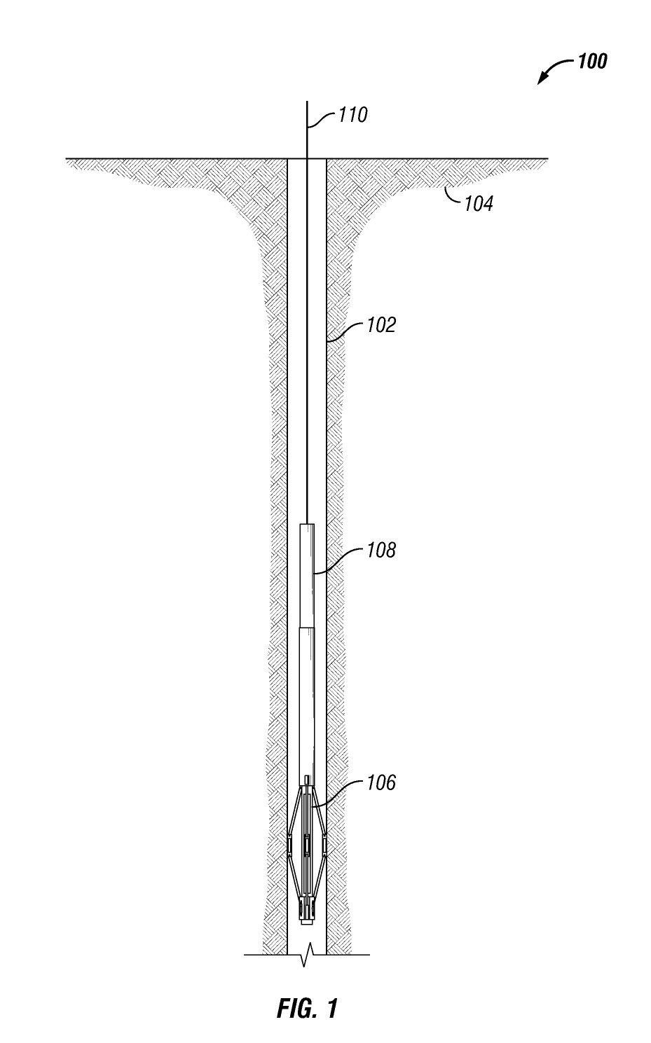

FIG. 1 illustrates an example “wireline” neutron imaging apparatus 100. The apparatus 100 is shown disposed within a wellbore 102 drilled through a subsurface formation 104. The apparatus 100 includes a neutron imaging instrument 106 and a telemetry cartridge 108 for providing communication between the apparatus 100 and a surface deployed recording system or “logging unit” (not shown). Signal communication between the recording system (not shown) and the apparatus 100, and electrical power to operate the apparatus 100 may be provided using an armored electrical cable (“wireline”) 110. The telemetry cartridge 108, the instrument 106 itself or a separate device may contain a sensor set (i.e., a directional sensor) 105 of any type known in the art that determines instrument orientation with respect to a geodetic, geomagnetic and/or gravitational reference to enable each neutron property measurement to be associated with the orientation of the instrument 106 with respect to such reference(s).

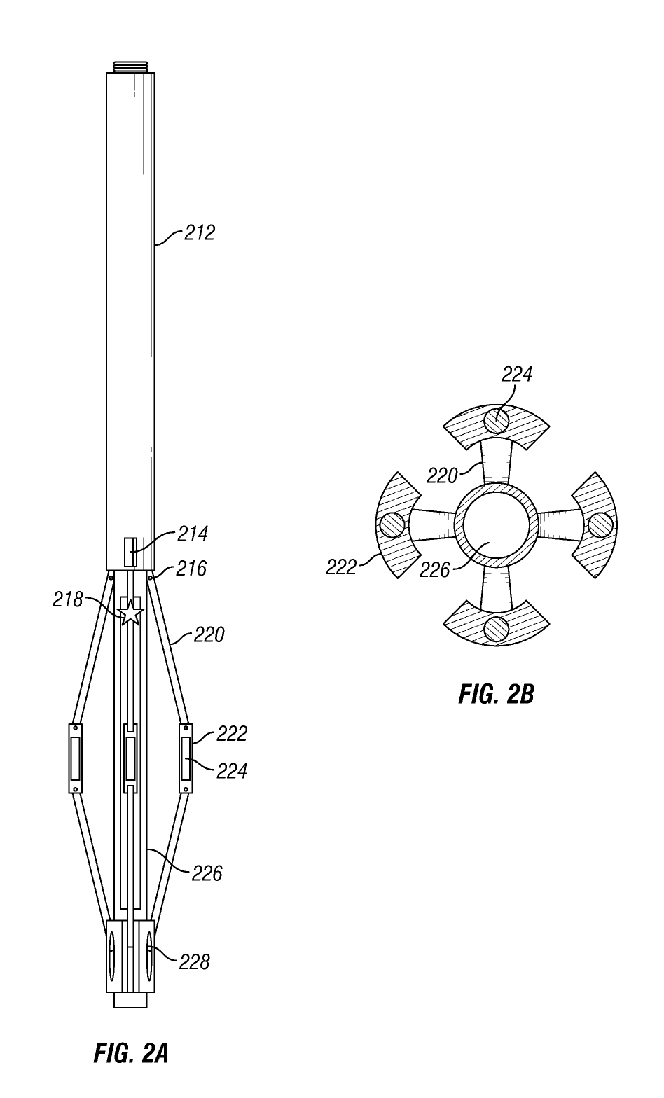

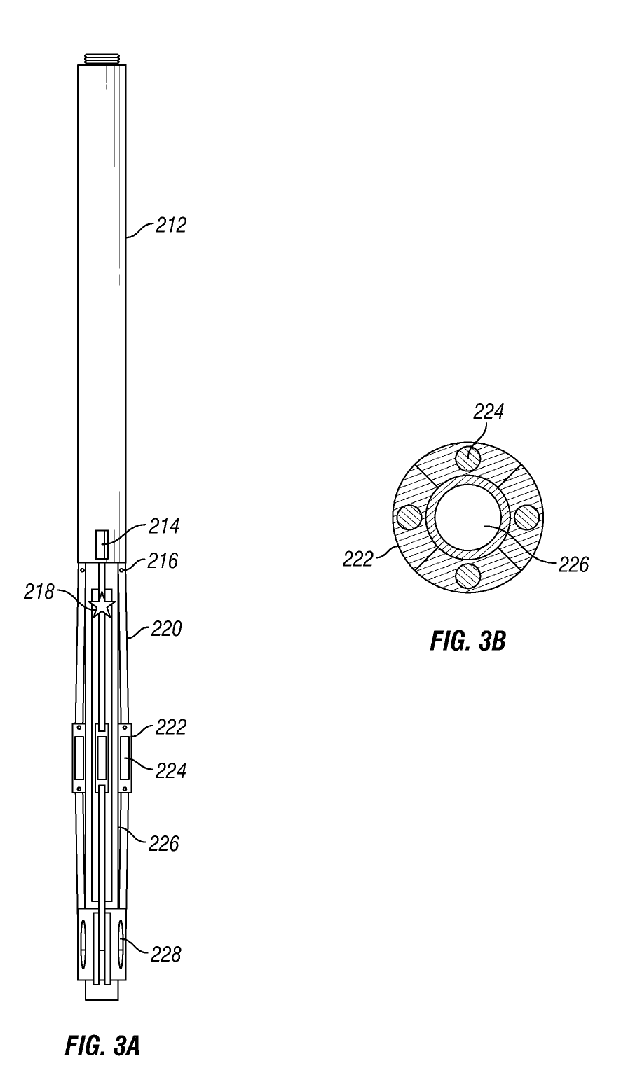

FIGS. 2A, 2B, 3A and 3B illustrate different views of a neutron imaging instrument 106 disposed in a housing 212. FIG. 2A illustrates a lengthwise view of the example neutron imaging instrument 106. The instrument 106 may include arms 220 that may be laterally displaced from the housing 212. The arms 212 are shown in the laterally displaced or expanded position. FIG. 2B illustrates a cross sectional view of the neutron imaging instrument 106 with the arms 220 expanded. The housing 212 may include a pulsed neutron source or a radioisotope neutron source 218. The housing 212 may also include a neutron monitor detector 214 spaced a selected distance distance from the neutron source 218, in particular when a pulsed neutron source is used. Measurements from the neutron monitor detector 214 may be used to adjust measurements made by various neutron detectors 222 disposed in detector pads 224 coupled to respective ones of the arms 220. The arms 220 may be coupled to the housing 220 at one longitudinal end thereof using respective fixed hinges 216. The opposite longitudinal end of each arm 220 may be coupled to a collar 228 that is configured to slide along the exterior surface of the housing 220. Electronic circuits 230 to operate the neutron source, if a pulsed source is used and/or for detecting signals responsive to neutron effects measured by each detector 224 may be disposed in the housing 212. The circuits 230 may be in signal communication with the telemetry (108 in FIG. 1) so that the detector measurements or representations thereof may be transmitted to the recording unit (not shown). Additionally or alternatively, the circuits 230 may include a recording device, such as a random access memory, hard drive or similar data storage device to store the measurements until the instrument 106 is retrieved to the surface.

FIG. 3A illustrates a lengthwise view of the neutron imaging instrument 106 with the arms 220 in the retraced position. FIG. 3B illustrates a cross sectional view of the neutron imaging instrument 106 with the arms 220 retracted.

The instrument 106 and its housing 212 may consist of a larger diameter section above (e.g. 3⅝ inches), that is, longitudinally where the housing 212 is shown above the hinges 216 and below the collar 228, and a section with a reduced diameter mandrel below the hinges 216 including the arms 220 and the detector pads 222 and above the collar 228. If the detector pads 222 and the arms 220 are retracted as shown in FIG. 3A and FIG. 3B, for example by moving the collar 228 at one end of each the arm 220 longitudinally away from the hinges 216, the total outer diameter of the lower section may be approximately 4.5 inches. The description below assumes the use of a pulsed neutron generator 226 in the smaller portion. However, the use of a radioisotope source shown at 218 is possible if a pulsed neutron source is not used.

In an example implementation, the reduced diameter section contains all or part of a pulsed neutron source 226. The pulsed neutron source 226 may also be completely contained in the reduced size section. Alternatively, the pulsed neutron source 226 may be positioned at the place shown in FIG. 2A where the neutron source 218 is located so it would be partially or entirely contained in the larger diameter portion of the housing 212, i.e., above the hinges 216. Certain examples may provide for positioning of additional detectors 224 (neutron or gamma-ray and a neutron monitor 214 in the upper instrument section). In particular, an additional detector 430 to detect gamma-rays from inelastic neutron interactions or neutron capture gamma-rays may be placed in the larger diameter section to make it possible to maximize the diameter and therefore the detection efficiency of the additional detector 430.

The assembly shown schematically in FIGS. 2A, 2B, 3A and 3B may be used to determine neutron response of the formation to the neutrons imparted by the neutron source (either radioisotope or pulsed neutron). For example, the neutron porosity proximate each of the detectors 224 may be determined. Neutron porosity can be determined by measuring neutron detection (count) rates in one or more of the detectors 224 contained in each pad 222. The detectors 224 may be epithermal or thermal neutron detectors, such as ³He detectors. While ³He detectors 224 may be preferred in certain examples, any other suitable detector of thermal or epithermal neutrons may be used, for example, ⁶Li-glass, ¹⁰B-lined proportional counters, etc.

In one embodiment, the count rate of a single thermal or epithermal detector in each pad 222, normalized by the neutron output of the pulsed neutron source as detected by the neutron monitor detector 214 can be used directly to determine the formation neutron porosity. The foregoing approach uses the fact that at a sufficiently large spacing (of the order of eight inches or more), the neutron count rate at each detector is a monotonic function of the formation porosity for a given formation mineral composition (“lithology”). See Ellis and Singer, Well Logging for Earth Scientists (Springer 2007), 2nd edition, chapter 14. However, with a single detector 224 on each pad 222, there may be insufficient information to correct for environmental effects, in particular standoff (distance between the detector and the formation at the wellbore wall, wellbore fluid salinity and wellbore diameter. If a neutron generator is used as the neutron source, it may be necessary to normalize the count rate of the thermal or epithermal neutron detector by the neutron flux determined from the neutron monitor.

If thermal neutron detectors are used, additional information can be obtained from the build up and the decay of the thermal neutron count rate during and after operating of a pulsed neutron source (the “burst” or a sequence of several bursts). This may enable making corrections for wellbore fluid salinity and other effects of thermal neutron absorbers on the count rates from each detector. If an epithermal detector is used, the neutron slowing down time may be used directly or in combination with the neutron monitor normalized detector count rate to determine the formation neutron porosity because the effects of thermal neutron absorbers is minimized.

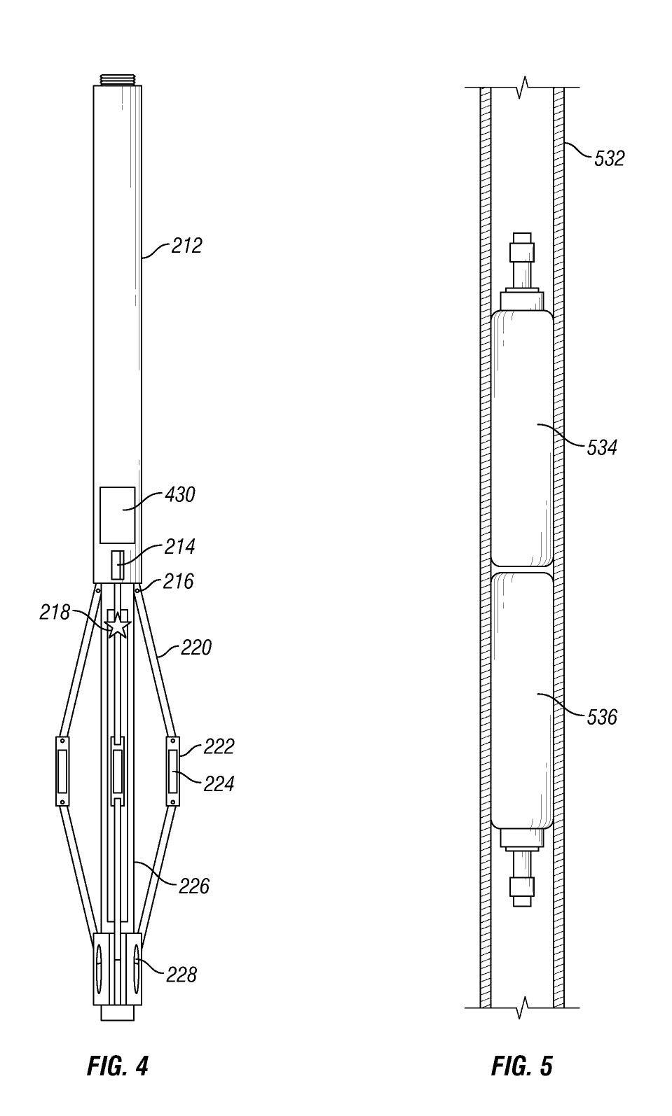

FIG. 4 illustrates an example neutron imaging tool 106 with the addition of the above mentioned gamma-ray detector 430. The gamma-ray detector 430 may be used to detect capture gamma rays, inelastic scatter gamma rays and to perform neutron activation gamma-ray spectroscopy. The illustrated gamma ray detector 430 is mounted within the interior of the housing 212, where there may be enough room internally for a large diameter detector suited for the detection of high energy (up to about 10 MeV) gamma-rays. In many applications there will be neutron and gamma-ray shielding (not shown) disposed between the gamma-ray detector 430 and the neutron source 218. While the neutron monitor 214 is shown on axis with the neutron generator 218 other positions for the neutron generator 218 or the monitor 214, e.g., laterally displaced to the interior side wall of the housing 212 may be used.

In alternative embodiments, the example instruments explained above can also be used with a radioisotope source, as previously explained. In such a case, there may not be any need for a neutron monitor 214, as the output of the radioisotope source can be determined through periodic calibrations.

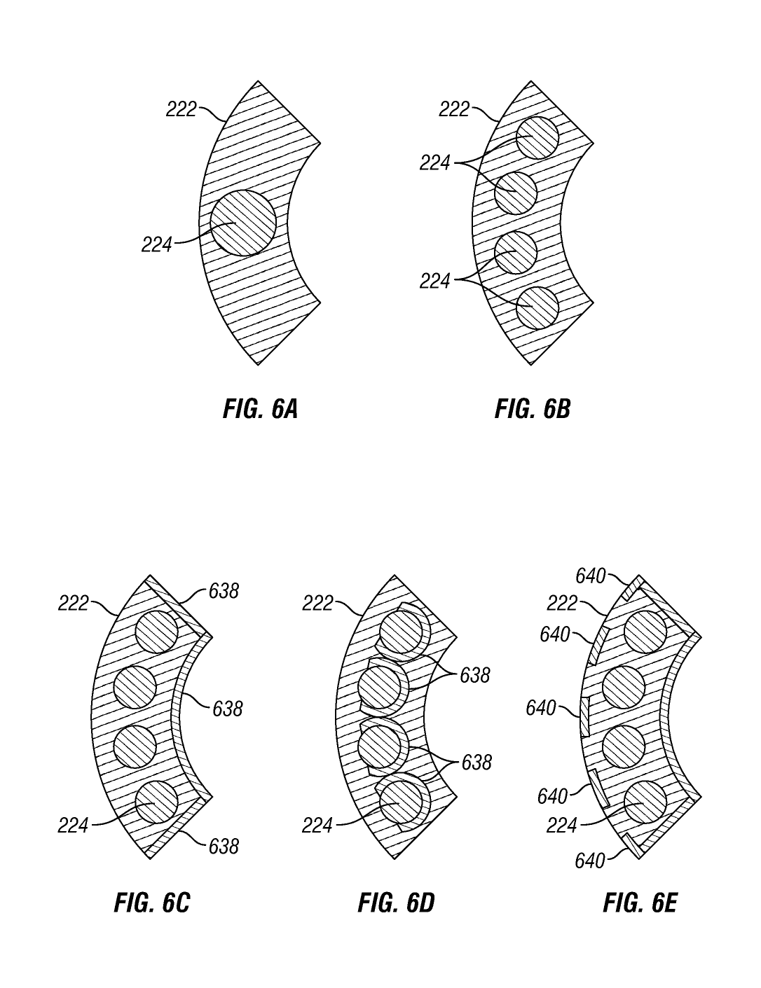

FIGS. 5 and 6A-E show various example detector configurations in each pad 222. FIG. 5 illustrates a pad 222 with two detectors 534, 536 at different longitudinal spacings from the source 218. The neutron detectors 534, 536 may be thermal detector 536 or epithermal detectors 534, or a mix of the two, and may be disposed within a pressure resistant housing 532 coupled to or formed in each pad 222. While ³He detectors are shown, any other suitable detector of thermal or epithermal neutrons, such as ⁶Li-glass, borated scintillation detectors, vacuum multiplier based detectors, etc. can be used.

FIGS. 6A-E illustrate various alternative neutron detector configurations with multiple detectors 224 at different azimuthal positions within each pad 222, according to alternative exemplary embodiments. In the illustrated examples, the multiple detectors 224 may each be at the same longitudinal distance from the neutron source (218 in FIG. 2A). FIGS. 6A and 6B show single and multiple detectors 224, respectively, disposed in the pad 222 structure. FIGS. 6C, 6D and 6E show examples of neutron back shielding 638 and/or front neutron shielding and collimators 640 (FIG. 6E) disposed in the pad 222 to reduce the number of neutrons arriving and subsequently detected from the wellbore (backshielding) and to increase the directionality of the sensitivity of the neutron detectors in the direction of the formation (104 in FIG. 1), such directional sensitivity is known as front collimation. The neutron shielding material can be any suitable neutron absorber such as ¹⁰B, ⁶Li, Cd, Gd, etc.

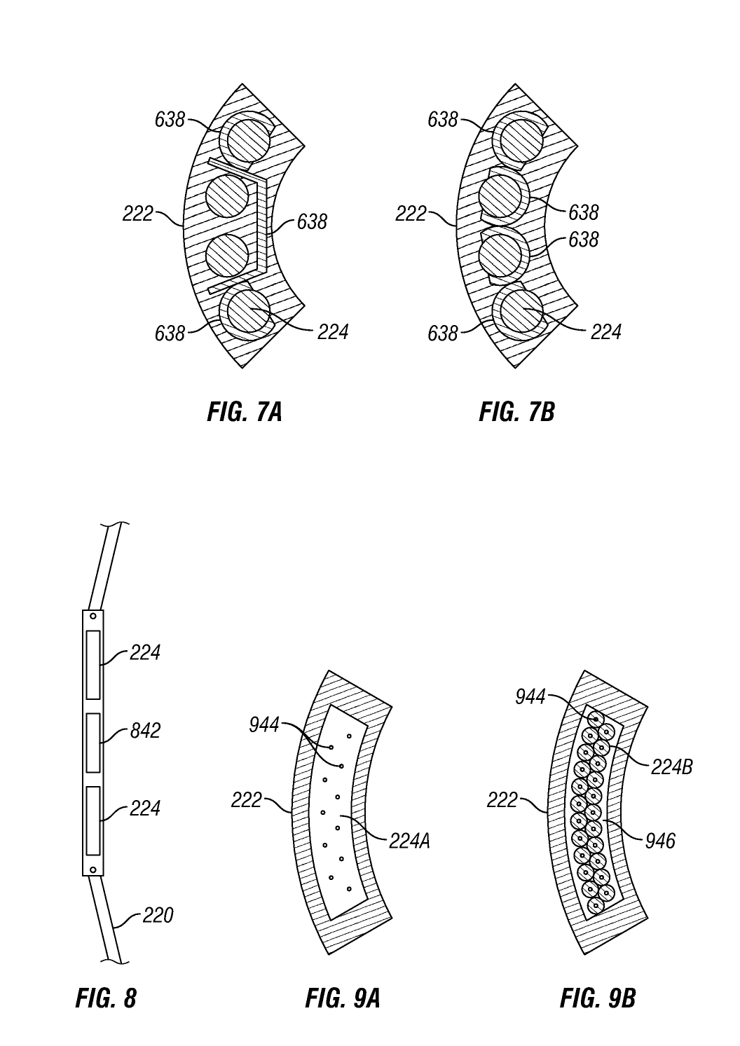

In order to obtain better compensation of the neutron detector response for the effects of the wellbore, one or more thermal or epithermal detectors could be installed in respective pads that face the wellbore wall and which are shielded so as to preferentially detect neutrons emanating from the wellbore. Examples of such detector configurations are shown in FIGS. 7A and 7B. FIGS. 7A and 7B illustrate alternative neutron detector configurations. FIG. 7A shows a configuration in which the neutron detectors 224, either epithermal, thermal or a mix thereof, are either wellbore or formation focused using shielding 638 around the two formation facing detectors. The shielding 638 may be reversed to make the remaining detectors 224 more sensitive to neutrons emanating from the formation. FIG. 7B shows a configuration in which each of the detectors 224 includes its own shielding 638, to direct sensitivity of the respective detector so that it faces the formation or the wellbore. In some examples, a possible shielding material would be enriched ¹⁰B (>20% ¹⁰B isotopic content compared to total boron content). Various methods for the construction of the shielding 638 are possible (e.g., boron-containing rubber including either metallic boron or boron carbide (B₄C), coatings of B₄C on a metal surface, etc.). As previously stated the selection of shielding materials is not limited to boron containing material.

Additionally, sets consisting of one or more detectors 224 can be positioned at additional longitudinal distances from the neutron source 218. An example is shown in FIG. 8, which shows two longitudinally spaced apart detectors 224 disposed in the pad 222. The detectors 224 in each pad 222 may be separated by an intermediate space 842. This space could contain electronic circuits (e.g., amplifier, discriminator, HV supply, etc.) for processing the signals from each detector 224.

FIGS. 9A and 9B illustrate examples of multiple neutron detectors 224 in each pad 222. In an example shown in FIG. 9A, the multiple detectors 224 in the pad 222 may be in the form a ³He-filled chamber having multiple detector electrode wires 224A to obtain enhanced angular position sensitivity. Additionally, resistive wires 944 can be used and the signal read out at both ends of each wire 944. This allows a determination of the vertical (axial) position of the neutron interaction in each such detector 244A.

In another example, as shown in FIG. 9B, the detector consists of a bundle or array 946 of small cylindrical neutron detectors 224B. Such detectors could be boron coated proportional counters, ³He tubes or other suitable detectors. As in the example shown in FIG. 9A, the electrode wires 944 in each detector 224B may be resistive and thus allow an axially position sensitive measurement.

For any of the foregoing examples, the position of the detector pads 222 with respect to the housing axis can be measured to obtain the proper correction for the varying source to detector spacing, both laterally and axially with reference to the amount of extension of each arm from the housing. This can be performed by a variety of approaches, such as those that may be recognized by one skilled in the art.

The various combinations of detector configurations described above may allow different neutron measurements based on thermal or epithermal count rates or near/far thermal or epithermal count rate ratios, slowing down time derived porosity and standoff (using epithermal detectors) with and without thermal or epithermal borehole corrections from borehole facing detectors (e.g., as explained with reference to FIGS. 7A and 7B). Additionally, the borehole size measured by the pad 222 arrangement can be used to refine the borehole corrections.

Porosity determination as well as the measurement of the macroscopic formation neutron capture cross section may be performed with approaches similar to those described in U.S. Patent Application Publication No. 2011/0238313 A1 filed by Thornton et al., the disclosure of which is hereby incorporated by reference. Normalization of count rates by a neutron monitor can be helpful if a pulsed neutron generator is used for the measurement.

Apparatus and methods according to the various aspects of the invention may provide the ability to generate a neutron property based, circumferentially segmented or referenced image of a wellbore without the need to rotate the instrument used to make neutron property measurements.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A well logging instrument comprising:
a housing shaped to traverse a wellbore drilled through subsurface formations;
a neutron source disposed within the housing;
a first plurality of neutron detectors, the first plurality, each of the first plurality of detectors disposed on a respective laterally extensible arm, the arms configured to urge the respective neutron detector into contact with a wall of the wellbore, the arms azimuthally separated from each other.

2. The well logging instrument of claim 1, wherein the neutron source comprises a radioisotope.

3. The well logging instrument of claim 1, wherein the neutron source comprises an electrically operated pulsed neutron generator.

4. The well logging instrument of claim 3 further comprising a neutron monitor detector in the housing proximate the pulsed neutron source.

5. The well logging instrument of claim 1, wherein at least one of the first plurality of neutron detectors comprises a thermal neutron detector.

6. The well logging instrument of claim 1, wherein at least one of the first plurality of neutron detectors comprises an epithermal neutron detector.

7. The well logging instrument of claim 1, wherein at least one of the first plurality of neutron detectors comprises a thermal neutron detector, and at least another one of the first plurality of neutron detectors comprises an epithermal neutron detector.

8. The well logging instrument of claim 1, wherein at least one of the plurality of neutron detectors comprises a multi-wire detector with azimuthal sensitivity.

9. The well logging instrument of claim 1, wherein at least one of the plurality of neutron detectors comprises an assembly of multiple neutron detectors to obtain azimuthal sensitivity.

10. The well logging instrument of claim 1, wherein the neutron detectors generate an output signal related to an axial position therealong of detection of a neutron.

11. The well logging instrument of claim 1, wherein the neutron detectors comprise at least one of a ³He detector, a ¹⁰B coated proportional counter, and a ⁶Li glass detector

12. The well logging instrument of claim 1, wherein the neutron detectors comprise electron multiplier devices using coatings of neutron reactive materials, the neutron reactive materials comprising at least one of ¹⁰B, ⁶Li, Cd, and Gd.

13. The well logging instrument of claim 1, wherein at least a portion of the first plurality of neutron detectors are disposed in a pad coupled to one of the plurality of arms, each neutron detector in the pad being shielded from neutrons coming from at least one of the borehole and the formation.

14. The well logging instrument of claim 14, wherein the shielding comprises neutron absorbers, the neutron absorbers comprising at least one of ¹⁰B, ⁶Li, Cd and Gd.

15. The well logging instrument of claim 1, wherein at least one of the arms includes two longitudinally spaced apart neutron detectors.

16. The well logging instrument of claim 1, wherein the count rate of the plurality of neutron detectors is normalized by a neutron flux determined by at least one of calibration and measurement made by a neutron monitor detector disposed at a selected distance from the neutron source.

17. The well logging instrument of claim 1, further comprising at least one gamma-ray detector for measuring the gamma-rays resulting from the interactions of the neutrons with the formation, borehole and tool.

18. The well logging instrument of claim 1, wherein the gamma-ray detector is mounted in a larger part of the tool housing, the larger part being longitudinally displaced from the arms.

19. The well logging instrument of claim 1, further comprising shielding against at least one of neutron and gamma-rays between the neutron source and the gamma-ray detector.

20. The well logging instrument of claim 1, wherein the detected gamma-rays are due to at least one of inelastic reactions and capture reactions of the neutrons.

21. The well logging instrument of claim 1, wherein the detected gamma-rays are due to an activation of elements in at least one of the formation and the borehole.

22. A method for logging a wellbore, comprising:
imparting neutrons into a formation surrounding a wellbore;
measuring a neutron response of the formation surrounding the wellbore in a plurality of substantially constant azimuthal orientations at positions proximate a wall of the wellbore.

23. The method of claim 22, wherein the imparting neutrons comprises placing a radioisotope in the wellbore.

24. The method of claim 23, wherein the imparting neutrons neutron comprises operating a pulsed neutron source.

25. The method of claim 24 further comprising measuring a fast neutron flux from the pulsed neutron source.

26. The method of claim 22, wherein the measuring neutron response comprises detecting thermal neutrons.

27. The method of claim 22, wherein the measuring neutron response comprises detecting epithermal neutrons.

28. The method of claim 22, wherein the measuring neutron response comprises detecting gamma rays resulting from interaction of the imparted neutrons with the formation.

29. The method of claim 28, wherein the detected gamma-rays result from at least one of inelastic reactions and capture reactions of the imparted neutrons.

30. The method of claim 22, wherein the measuring neutron response at each azimuthal direction comprises measuring neutron response at a plurality of azimuthal directions at each position.

31. The method of claim 30, wherein the detecting neutron response at each of the plurality of azimuthal directions at each position is shielded from neutrons emanating from at least one of the wellbore and the formation.

32. The method of claim 22 wherein the measuring neutron response comprises detecting neutrons at predetermined positions with respect to a position of the imparting neutrons.

33. The method of claim 22, wherein the detecting neutron response is performed at two different longitudinal spacings from a position of the imparting neutrons at a same azimuthal orientation.
